(19) United States
(12) Patent Application Publication
(10) Pub. No.: US 2016/0044562 A1
(43) Pub. Date: Feb. 11, 2016

(54) METHOD OF SWITCHING CONNECTION TO FEMTOCELL AND WIFI AP IN SDN

(71) Applicant: INNOWIRELESS CO., LTD., Gyeonggi-do (KR)

(72) Inventors: Jin Soup Joung, Gyeonggi-do (KR); Seung Hwan Ji, Gyeonggi-do (KR); Hyun Seok Lee, Seoul (KR); Woong Jong Jeong, Jeollanam-do (KR); Jung Hoon Seo, Ulsan (KR)

(21) Appl. No.: 14/600,453

(22) Filed: Jan. 20, 2015

(30) Foreign Application Priority Data
Aug. 7, 2014 (KR) 10-2014-0101914

(51) Int. Cl. H04W 36/14; H04W 76/02

(52) U.S. Cl. CPC H04W 36/14; H04W 76/025; H04W 84/045

(57) ABSTRACT

A method of switching a connection to a femtocell and a WiFi access point (AP) in software defined networking (SDN) capable of minimizing inconvenience of use by automatically switching a connection to a mobile communication network including the femtocell and a WiFi network connected to the SDN without disconnection of a data service in a state that a user does not recognize is provided.

### CROSS-REFERENCE TO RELATED APPLICATION

This application claims priority to and the benefit of Korean Patent Application No. 10-2014-0101914, filed on Aug. 7, 2014, the disclosure of which is incorporated herein by reference in its entirety.

### FIELD OF THE INVENTION

The present invention relates to a method of switching a connection to a femtocell and a WiFi access point (AP) in software-defined networking (SDN), and more particularly, to a method of switching a connection to a femtocell and a WiFi AP in SDN so that a connection to a mobile communication network including a femtocell and a WiFi network connected to the SDN is automatically switched in a state that a user does not recognize

### BACKGROUND OF THE INVENTION

As well known, a femtocell base station (hereinafter, it is simply called “a femtocell”) is an ultra micro mobile communication base station capable of accessing a mobile communication core network through a broadband network installed indoors such as home or office. The femtocell has an advantage capable of increasing an indoor coverage, improving a communication quality, and effectively providing various wired and wireless fusion services.

Meanwhile, in third generation partnership project (3GPP) long term evolution (LTE), a station which is called an evolved nodeB (eNB) and a home eNB is defined. The eNB of them is a macro base station managing a general macro cell, and the HeNB is a femtocell base station managing a femtocell. That is, in the 3GPP, an environment in which a femtocell in which only a specific user can access besides a conventional macro base station is installed is considered.

Here, the femtocell may be installed for the purpose of coverage increase, capacity increase, or provision of other differentiated services, etc. by a user or a business operator. A service coverage of the femtocell may be considered from at least about a few meters to a maximum macro service coverage.

Software-defined networking (SDN) is a network or paradigm of a new structure which came to the fore in order to fundamentally solve and renovate a structural problem in which a current Internet has by software, and is a concept including an application, a network operating system, hardware abstraction, a standardized interface, and hardware.

The SDN is a network structure in which a network control plane is separated from a physical network having a data transfer plane, and the separated control plane should necessarily have a plane capable of interacting with a data path in a network switch (hardware). One of the interaction or a communication mechanism is OpenFlow technology which is a standard interface for communication between a machine having the control plane and the network switch.

According to the SDN, the control plane which is called a controller is implemented in a separate machine instead of a switch or a router, and the machine may be a personal computer (PC) or a high-performance server.

Meanwhile, according to a conventional art, many users alternately use the mobile communication network including a femtocell and the WiFi network by reason of a service fee or a transmission speed when using wireless data, and inconvenience in which a data service is disconnected can be generated in the process of switching the network.

This work was supported by the ICT R&D program of MSIP/IITP, Republic of Korea. [13-911-05-001, Development of OpenFlow-based integrated management system for wired and wireless network]

### PRIOR ART DOCUMENTS

1. Korea Patent Publication No. 10-2013-0017709 (Base station device and virtualization base station system for controlling data offloading connection)
2. Korea Patent Publication No. 10-2014-0001244 (Network device and method of determining connection context with respect to connection used for local offloading)

### SUMMARY OF THE INVENTION

The present invention is directed to a method of switching a connection to a femtocell and a WiFi access point (AP) in software defined networking (SDN) capable of minimizing inconvenience of use by automatically switching a connection to a mobile communication network including the femtocell and a WiFi network connected to the SDN without disconnection of a data service in a state that a user does not recognize.

According to an aspect of the present invention, there is provided a method of switching a connection to a femtocell and a WiFi access point (AP) in SDN, wherein a mobile communication terminal is connected to the femtocell of a mobile communication network or the WiFi AP adjacent thereto connected to an SDN switch wirelessly in SDN including the SDN switch and an SDN controller separated from the SDN switch and configured to control the SDN switch, the method including: (a) detecting that the mobile communication terminal enters, and reporting the detecting fact to the SDN controller through the SDN switch, by the femtocell; (b) instructing the mobile communication terminal to connect to the adjacent WiFi AP by activating a WiFi module of itself through the SDN switch and the femtocell, by the SDN controller; and (c) connecting to the WiFi AP after activating the WiFi module of the mobile communication terminal itself in a state that the mobile communication terminal is connected to the femtocell, by the mobile communication terminal.

The operation (a) may be performed by analyzing a local update message or a handover message transmitted to a mobile communication core network through the femtocell, by the mobile communication terminal.

The method may further include: (d) receiving a wireless status report message including wireless channel status information of each of the femtocell and the WiFi AP, by the SDN controller; (e) determining whether it is possible to offload by checking whether the wireless channel status of each of the femtocell and the WiFi AP satisfies a predetermined condition, by the SDN controller; and (f) instructing the SDN switch so as to transmit and receive data through the femtocell when it is not possible to offload based on the determining result of the operation (e), and the SDN switch so as to transmit and receive the data through the WiFi AP when it is possible to offload.

The operation (d) may transmit the wireless status report message periodically or transmit the wireless status report message based on a result of comparing a value indicating a specific wireless status with a reference value.

The mobile communication terminal may include a WiFi module device file transmitting and receiving wireless data through a WiFi interface, a 3G/4G module device file transmitting and receiving the wireless data through the mobile communication network, a virtual device driver device file, and a transmission task for transmission and a reception task for reception among the WiFi module device file, the 3G/4G module device file, and the virtual device driver device file, and an application program installed in the mobile communication terminal may transmit and receive data through the virtual device driver device file, the transmission task may transmit the data to the WiFi module device file or the 3G/4G module device file after reading the data in which the application program transmits from the virtual device driver device file, and the reception task may transmit the data received from the WiFi module device file or the 3G/4G module device file to the application program through the virtual device drive device file.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a sequence chart for describing a method of switching a connection to a femtocell and a WiFi access point (AP) in software defined networking (SDN) according to an embodiment of the present invention;

FIG. 2 is a diagram for describing an operation of automatically activating a WiFi module of a terminal when the terminal enters a service area of a femtocell in a method of switching a connection to the femtocell and a WiFi AP in SDN according to an embodiment of the present invention;

FIG. 3 is a diagram for describing an operation of offloading through a femtocell and a WiFi AP in a method of switching a connection to the femtocell and the WiFi AP in SDN according to an embodiment of the present invention; and

FIG. 4 is a diagram for describing an operation of combining and processing data after a terminal simultaneously receives the data from a femtocell and a WiFi AP in a method of switching a connection to the femtocell and the WiFi AP in SDN according to an embodiment of the present invention.

### DETAILED DESCRIPTION

Hereinafter, exemplary embodiments of a method of switching a connection to a femtocell and a WiFi AP in SDN according to the present invention will be described in detail with reference to the accompanying drawings.

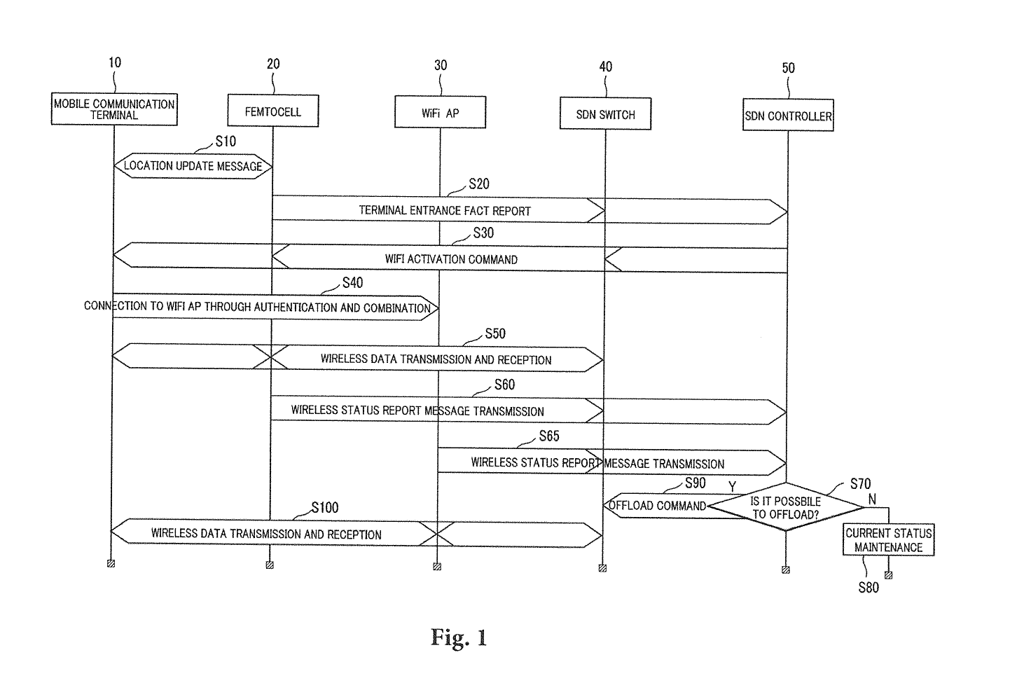

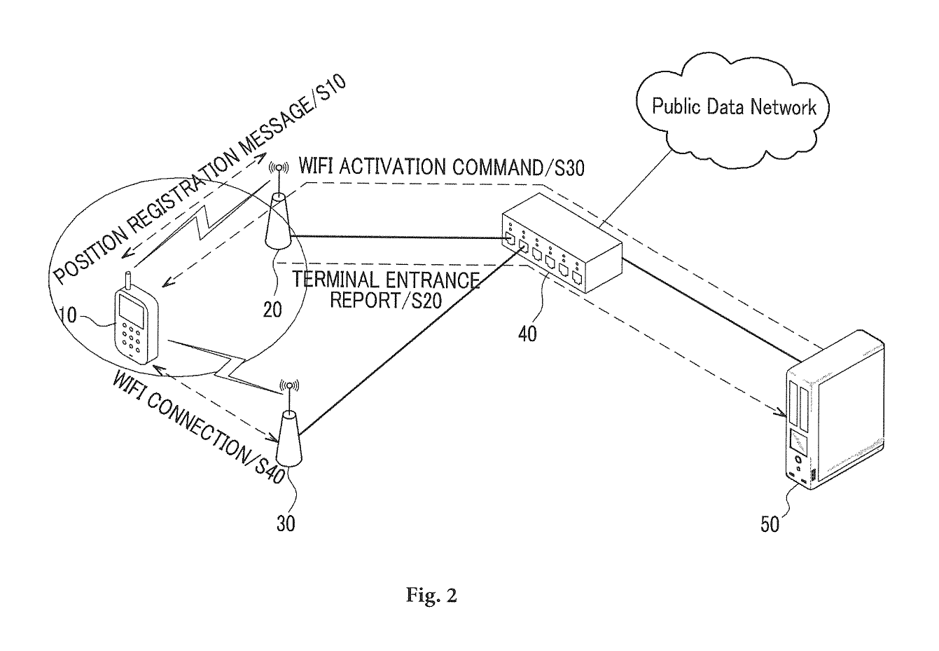

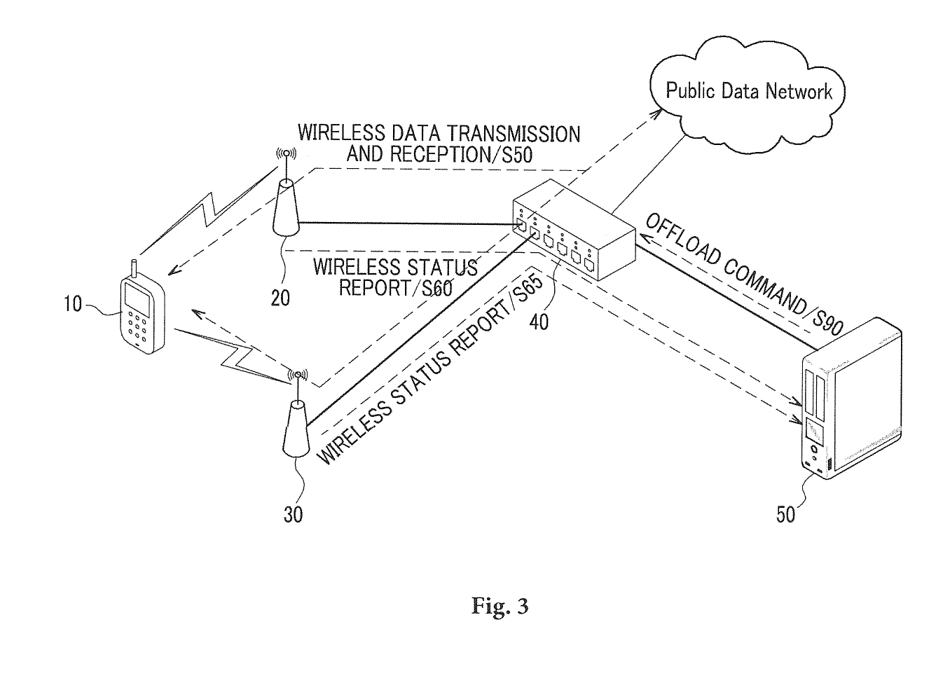

FIG. 1 is a sequence chart for describing a method of switching a connection to a femtocell and a WiFi access point (AP) in software defined networking (SDN) according to an embodiment of the present invention, and FIG. 2 is a diagram for describing an operation of automatically activating a WiFi module of a terminal when the terminal enters a service area of a femtocell in a method of switching a connection to the femtocell and a WiFi AP in SDN according to an embodiment of the present invention. FIG. 3 is a diagram for describing an operation of offloading through a femtocell and a WiFi AP in a method of switching a connection to the femtocell and the WiFi AP in SDN according to an embodiment of the present invention.

As shown in FIGS. 1 to 3, a construction of a network in which a method of the present invention is implemented may include a mobile communication terminal 10, a femtocell 20, a WiFi AP 30, an SDN switch 40, and an SDN controller 50.

In the construction described above, the mobile communication terminal 10 may be a terminal having a third generation (3G) or fourth generation (4G) mobile communication interface and a WiFi interface prescribed in an IEEE 802.11, and may be a conventional smart phone, a smart pad (tablet personal computer (PC)), or a notebook PC, etc. The WiFi AP 30 may be an apparatus having a wireless LAN interface prescribed in the IEEE 802.11 and an Ethernet interface prescribed in an IEEE 802.3, and may be an apparatus capable of receiving data in which the mobile communication terminal 10 transmits wirelessly and transmitting the data to a wired network through an Ethernet port, or vice versa. The femtocell 20 may be a home evolved nodeB (HeNB) defined in a 3GPP wideband code division multiple access (WCDMA) or a 3GPP LTE, and may be a base station managing the femtocell.

Next, in the SDN, the SDN controller 50 performing a network control plane may be separated from the SDN switch 40 which is a physical device performing a data plane operation, the SDN controller 50 may be implemented as a PC or a high performance server, and the SDN switch 40 may be a conventional router, etc. The SDN switch 40 may be connected to a public data network (PDN) such as an Internet, and may be connected to the femtocell 20 and the WiFi AP 30.

Meanwhile, an agent program for performing communication between the SDN switch 40 and the SDN controller 50 may be installed in the WiFi AP 30 according to the present invention.

In a network system having the structure described above, when the mobile communication terminal 10 enters a service area of the femtocell 20, a position registration message or a handover message may be transmitted to a mobile communication core network (operation S10). In this operation, the femtocell 20 may analyze the location update message or the handover message transmitted from the mobile communication terminal 10, detect that a new terminal enters its own service area, and report the detection results to the SDN controller 50 (operation S20).

Next, the SDN controller 50 which receives the detection results may transmit a message for automatically activating an inner WiFi module to the mobile communication terminal 10 through the femtocell 20 (operation S30), and the message may include information regarding the WiFi AP 30 to which the mobile communication terminal 10 is connected, for example, a service set identifier (SSID) address, etc. Here, the SDN agent program of the mobile communication terminal 10 may receive and process an activation command of the WiFi module from the SDN controller 50.

Next, the mobile communication terminal 10 may receive the activation command of the WiFi module, activate the WiFi module included in the mobile communication terminal 10 itself, perform an authentication and connection operation with the WiFi AP 30 which coexists with the femtocell, and connect to the WiFi AP 30 (operation S40). At this time, when supposing that it is possible for the mobile communication terminal 10 to simultaneously connect to the femtocell 20 and the WiFi AP 30 through a 3G/4G module and the WiFi module, the mobile communication terminal 10 may prepare in order to simultaneously receive data through the femtocell 20 and the WiFi AP 30 by performing the operation. After performing the operation described above, the mobile communication terminal 10 may transmit and receive wireless data through a mobile communication network, that is, the femtocell 20 and the SDN switch 40 (operation S45).

Meanwhile, each of the femtocell 20 and the WiFi AP 30 may transmit a wireless status report message including its own wireless channel status information to the SDN controller 50 (operations S60 and S65), and the wireless status report message may be periodically transmitted or may be transmitted according to a result of comparing a value indicating a specific wireless status and a reference value. That is, the wireless status report message may be transmitted in various situations.

Next, the SDN controller 50 may check whether the wireless channel status reported by the femtocell 20 and the WiFi AP 30 satisfies a condition which is previously specified, and determine whether it is possible to offload (operation S70). If not, the SDN controller 50 may maintain a current status at it is (operation S80). That is, the wireless data may be received and transmitted through the femtocell 20, and on the other hand, if possible, the SDN controller 50 may transmit an offload command to the SDN switch 40 (operation S90), and control to transmit and receive the wireless data through the WiFi AP 30 (operation S100). Here, the transmission path of the data may be changed, but contents of the data such as the destination address, etc may not be changed.

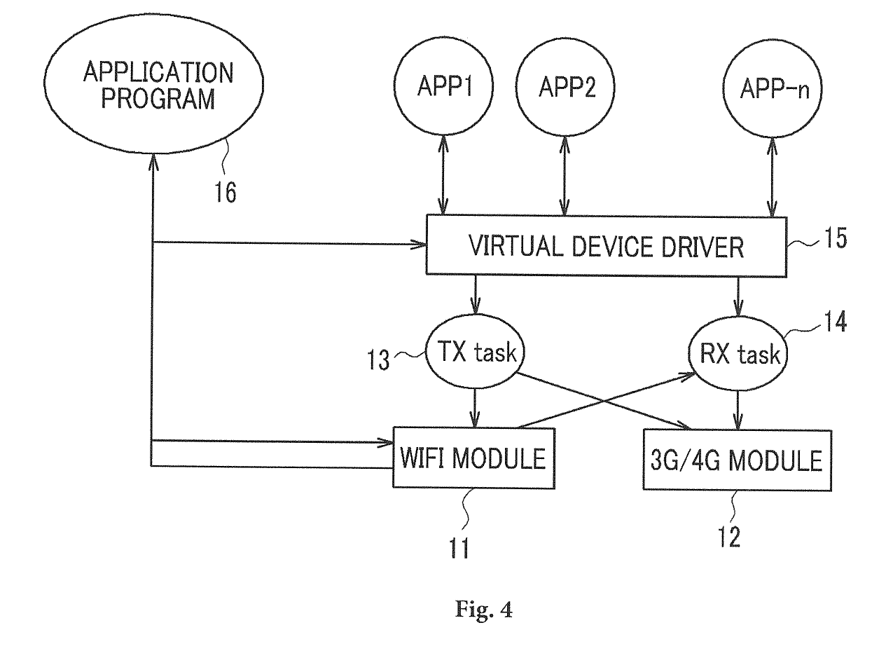

FIG. 4 is a diagram for describing an operation of combining and processing data after a terminal simultaneously receives the data from a femtocell and a WiFi AP in a method of switching a connection to the femtocell and the WiFi AP in SDN according to an embodiment of the present invention.

As shown in FIG. 4, the mobile communication terminal 10 in which the method according to the present invention is implemented may receive the wireless data regardless of whether the transmission path of the wireless data transmitted to the mobile communication terminal 10 itself passes through the femtocell 20 or the WiFi AP 30. For this, the mobile communication terminal 10 may generate a WiFi module device file 11 transmitting and receiving the wireless data through the WiFi interface, a 3G/4G module device file 12 transmitting and receiving the wireless data through the mobile communication network, and a virtual device driver device file 15.

Meanwhile, there may be a transmission task 13 for transmission and a reception task 14 for reception among the WiFi module device file 11, the 3G/4G module device file 12, and the virtual device driver device file 15. In this structure, each of one or more application programs 16 installed in the mobile communication terminal 10 may transmit and receive data through the virtual device driver device file 15. The transmission task 13 may transmit data to the WiFi module device file 11 or the 3G/4G module device file 12 after reading the data of the application program in which each application program transmits from the virtual device driver device file 15, and whether to transmit the data to any of the device files may be determined by the WiFi module device file 11.

Meanwhile, the reception task 14 may perform a function of transmitting data received from the WiFi module device file 11 or the 3G/4G module device file 12 to the virtual device driver device file 15 to which the application program 16 is connected.

According to the method of switching the connection to the femtocell and the WiFi AP in the SDN, a wireless data service can be seamlessly provided regardless of a place by automatically switching the connection to the mobile communication network including the femtocell and the WiFi network connected to the SDN without disconnection of the data service in a state that the user does not recognize

Hereinbefore, exemplary embodiments of the method of switching the connection to the femtocell and the WiFi AP in the SDN were described in detail, but they are only an example. It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of switching a connection to a femtocell and a WiFi access point (AP) in software-defined networking (SDN), wherein a mobile communication terminal is connected to the femtocell of a mobile communication network or the WiFi AP adjacent thereto connected to an SDN switch wirelessly in SDN including the SDN switch and an SDN controller separated from the SDN switch and configured to control the SDN switch, the method comprising:
(a) detecting that the mobile communication terminal enters, and reporting the detecting fact to the SDN controller through the SDN switch, by the femtocell;
(b) instructing the mobile communication terminal to connect to the adjacent WiFi AP by activating a WiFi module of itself through the SDN switch and the femtocell, by the SDN controller; and
(c) connecting to the WiFi AP after activating the WiFi module of the mobile communication terminal itself in a state that the mobile communication terminal is connected to the femtocell, by the mobile communication terminal.

2. The method of switching the connection to the femtocell and the WiFi AP of claim 1, wherein the operation (a) is performed by analyzing a location update message or a handover message transmitted to a mobile communication core network through the femtocell, by the mobile communication terminal.

3. The method of switching the connection to the femtocell and the WiFi AP of claim 2, further comprising:
(d) receiving a wireless status report message including wireless channel status information of each of the femtocell and the WiFi AP, by the SDN controller;
(e) determining whether it is possible to offload by checking whether the wireless channel status of each of the femtocell and the WiFi AP satisfies a predetermined condition, by the SDN controller; and
(f) instructing the SDN switch so as to transmit and receive data through the femtocell when it is not possible to offload based on the determining result of the operation (e), and the SDN switch so as to transmit and receive the data through the WiFi AP when it is possible to offload.

4. The method of switching the connection to the femtocell and the WiFi AP of claim 3, wherein the operation (d) transmits the wireless status report message periodically or transmits the wireless status report message based on a result of comparing a value indicating a specific wireless status with a reference value.

5. The method of switching the connection to the femtocell and the WiFi AP of claim 1, wherein the mobile communication terminal comprises a WiFi module device file transmitting and receiving wireless data through a WiFi interface, a 3G/4G module device file transmitting and receiving the wireless data through the mobile communication network, a virtual device driver device file, and a transmission task for transmission and a reception task for reception among the WiFi module device file, the 3G/4G module device file, and the virtual device driver device file, and
an application program installed in the mobile communication terminal transmits and receives data through the virtual device driver device file, the transmission task transmits the data to the WiFi module device file or the 3G/4G module device file after reading the data in which the application program transmits the virtual device driver device file, and the reception task transmits the data received from the WiFi module device file or the 3G/4G module device file to the application program through the virtual device drive device file.
